(19) United States
(12) Patent Application Publication
(10) Pub. No.: US 2014/0122282 A1
(43) Pub. Date: May 1, 2014

(54) System and Method for Mobile Gift Distribution

(71) Applicant: Carlos E. Orellana, Irvine, CA (US)

(72) Inventor: Carlos E. Orellana, Irvine, CA (US)

(73) Assignee: UBIQUITY BROADCASTING CORPORATION, Irvine, CA (US)

(21) Appl. No.: 14/061,567

(22) Filed: Oct. 23, 2013

Related U.S. Application Data
(60) Provisional application No. 61/717,563, filed on Oct. 23, 2012.

(51) Int. Cl. G06Q 30/06; G06Q 50/00

(52) U.S. Cl. CPC G06Q 30/0601; G06Q 50/01
USPC 705/26.1

(57) ABSTRACT

A computing system can be a cell phone that communicates with a social network. The social network can be a website that stores connections between people, and uses the user's login credentials to communicate with said social networking website. The processor automatically obtains event information about friends of the user from said social networking website, and displays said event information on said display. The user can purchase at least one digital gift for a recipient who is one of said friends having an amount and being redeemable for goods and/or services. That purchase is communicated to at least one of the friends, and automatically posted on the social networking website in a way that is shown to users of the social networking website other than the user and the recipient.

This application claims priority from provisional application No. 61/717,563, filed Oct. 23, 2012, the entire contents of which are herewith incorporated by reference.

### BACKGROUND

Mobile devices can be thought of as devices capable of accessing and computing data and that can be moved between locations. Mobile devices can also often operate to data remotely using a wireless connection. Mobile device features often include accessing email, sending and receiving messages, downloading and executing mobile applications, GPS navigation, camera, video, and other means of manipulating data remotely.

Current leaders in mobile device software include Apple IOS, Google Android, and Microsoft Windows Phone 7.

A social network is a site or forum where users share personal information. Social networks often allow users to connect with each other based on social associations in the social network.

Some social networks allow uploading and sharing photos, profiles, events, birthdays, groups, status updates, and other social and personal information. Current leaders in social networking include Facebook, MySpace, Foursquare, LinkedIn, and others, and mobile devices are providing additional remote access to such services.

A digital gift can be a certificate or voucher or substitute currency offered by a specific business or individual that is exchangeable for a cash value of goods or services. The electronic gift is referred to herein as a gift card, which is an electronic gift that has a code that allows it to be used by the recipient, e.g., a barcode or magnetic strip a reusable physical or virtual card. Gift certificates and gift cards have become popular gifts.

### SUMMARY

This invention relates to mobile gift distribution, and more particularly, to a system for distributing digital gifts among friends, either real or within social networks, using a digital format.

The inventors recognize a use for distributing digital gifts amongst friends in a social network.

Embodiments describe a system of distributing digital gifts among friends, either real or within social networks, using a digital format in real time with a mobile device. In one embodiment, the digital gift is referred to as a “gift card”.

Embodiments describe tracking purchase data and providing balance details for all received digital gifts. This is accomplished through interacting modules including a social networking module, an external social network integration module, a gift card purchasing module, and a gift card transaction module.

Another embodiment does all of this using a single computer that runs the functions to carry out these modules.

The social networking module is responsible for maintaining the social network database and communication with all clients.

The external social network integration module can scan for friends, events, and other information in separate social networks, parse this information for relevant data, and incorporate it into the social networking module. Included in these results are friends, birthdays, events, event invite lists, groups, and other relevant information.

Through the gift card purchasing module, the user may select an individual from their network and send them a digital gift such as a gift card. The gift card transaction module maintains and can provide a list of all sent gifts, all received gifts, and the individual transaction history for one or a plurality of gift cards.
These and other objectives of the present invention will become apparent to those of ordinary skill in the art after reading the following detailed description of the preferred embodiments. It is to be understood that the foregoing general description and the following detailed description are exemplary, and are intended to provide further explanation of the invention as claimed.

### BRIEF DESCRIPTION OF THE DRAWINGS

FIG. 1 depicts a block diagram of a computer system suitable for implementing aspects of the present invention;

FIG. 2 is a diagram illustrating the remote application;

FIG. 3 is a flowchart illustrating sending a digital gift card;

FIG. 4 is a flowchart illustrating making a purchase using a gift card;

FIGS. 5-28 are diagrams illustrating the system as described below; and

FIG. 29 is a flowchart illustrating the process of operation to obtain a digital gift.

### DETAILED DESCRIPTION

Embodiments of the present invention are described herein in the context of a mobile gift distribution system that distributes digital gifts using a network accessible system that has multiple users. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to embodiments and implementations as illustrated in the accompanying drawings. The same reference indicators will be used throughout the drawings and the following detailed description to refer to the same or like parts.

In the different embodiments, the techniques described herein can be run on a server computer or on a client computer or on both. One embodiment can include a server computer 102, a database 128 residing on the server, and interfaces to several wired and mobile clients 106, 108 capable of communicating with the server 102 via the Internet 104.

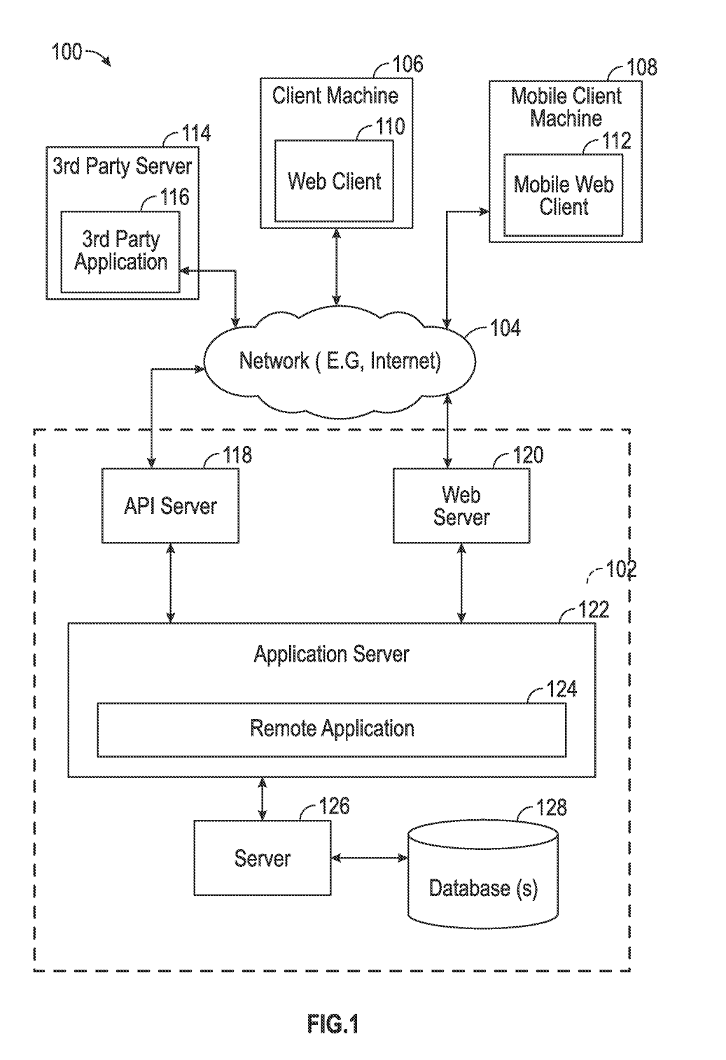

The overall operation is shown in FIG. 1. A server computer system 102 includes many of the functions, including a Web server 120, and an API server 118. Either or both of these connect to the Internet 104, and connect to a number of client computers. The main server 126 may also include an application server 122 and a remote application 124. The main server 126 communicates with a database 128 that stores the information described herein.

The server 102 connects over the Internet 104 2 clients 106 and 108. The client 106 may be any general kind of client, having a web client 110 that communicates with the Internet. The client 108 is shown as a mobile client, having the mobile web client 112.

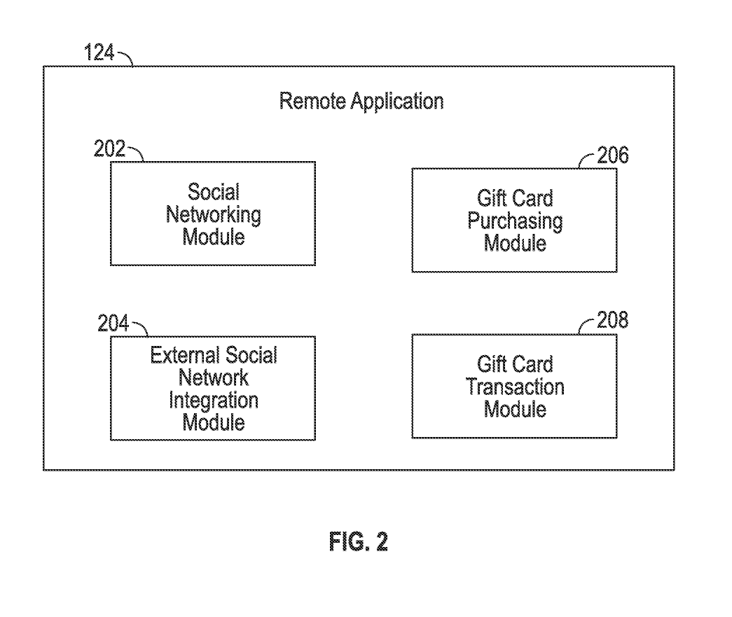

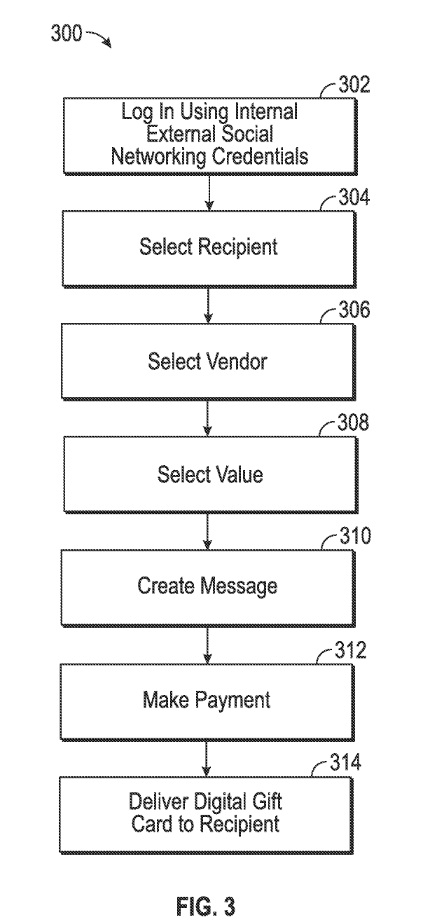

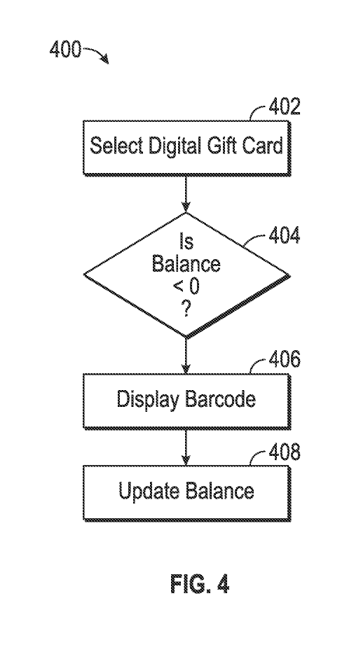

The operations are carried out by four different functional modules which can be embodied within a single computer program or in separate computer programs, e.g. separate websites. In FIG. 2, these are shown as part of the remote application 124, residing on the server. However, these can be in other locations. For example, FIG. 1 shows a third-party server 114 with a third-party application 116, also connected to the Internet 104. The functional modules can be located within or communicating with this third-party server 114.

The functional modules include a social networking module, an external social network integration module 202, a gift card purchasing module 206, and a gift card transaction module 208. The modules are capable of collaborating between an internal and several external social networks to provide a means for sending digital gift cards to individuals. The database can also provide a history of all transactions and gifts sent and received through the social networks. As the term module is used throughout this application, it should be understood that this can be a part of the single program, an individual program, a program running on a website or database, or any other functionality carried out in any way.

The social networking module 202 is responsible for maintaining the social network database and communication with all clients. This module maintains user profiles, user status updates, friends, photos, videos, groups, purchase history, and other common social networking features. This module further maintains birthdays and user-created events for each individual in the network, with each event having a user list. In a preferred embodiment, these events will be visible to all/friends within the user's network, providing an easy way to connect with friends and send gift cards for specific events.

The social networking module 202 may also contain private information, such as the user's physical address, phone number, and credit card information.

The social networking module 202 may further populate its database through the external social network integration module 204. Here, the user may use the external social network integration module 204 to link other social networks, such as Facebook, Twitter, and LinkedIn, to obtain information from those social networks. These my plug-in to interfaces with the existing social networks, or alternatively, may open the webpage of these social networks and obtain whatever personal information the user can obtain based on the user's login credentials.

In an alternative embodiment, the external social network module 204 may be used to send gifts without integration into the social networking module.

In a further alternative embodiment, the user may create an event using the social networking module 202 and invite friends to the event from their friend list which can be either locally stored, or obtained from the social network via the integration module 204. The external social network integration module 204 then scans for friends, events, and other information, parse this information for relevant data, and incorporate it into the social networking module 202. Included in these results are friends, birthdays, events, event invite lists, groups, and other relevant information. Individuals with upcoming events or birthdays may be highlighted or otherwise emphasized to encourage sending of a digital gift. Additionally, if an event is created using the user interface described according to the embodiments, that event may be incorporated into the linked external social networks.

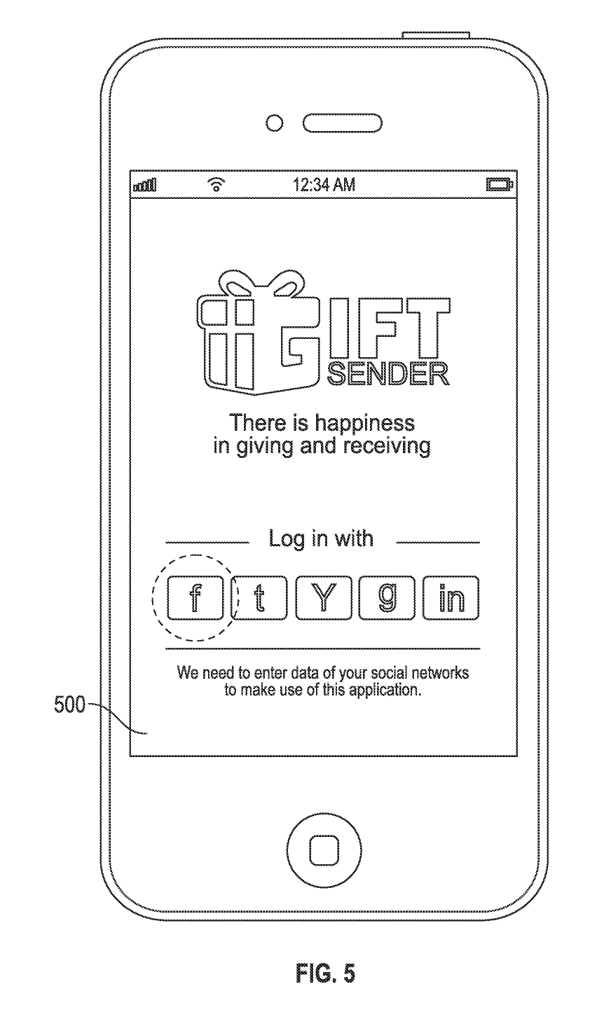

Through the gift card purchasing module 206, the user may select an individual from their network and send them a gift card. FIG. 5 shows the user interface 500 for a first embodiment, as displayed on a display screen of a mobile phone. This shows the gift sender application running on the mobile phone, with its logo, and the ability to login using social networks. By logging in via a social network, the gift sender application obtains information from that logged-in social network.

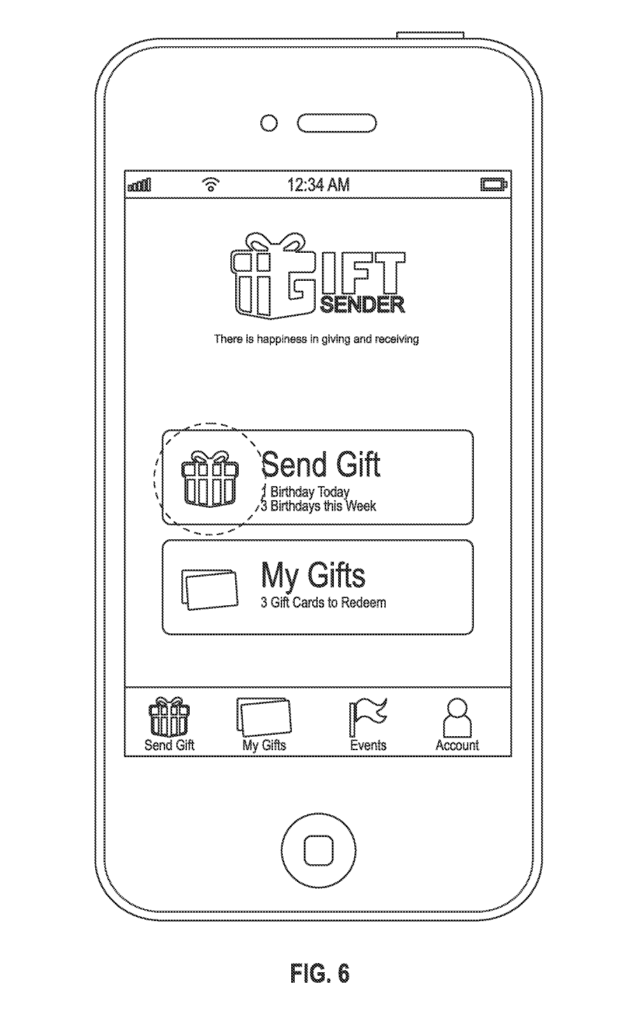

FIG. 6 shows the screen allowing the user to send a gift to others, and also to view gifts that have been received from others. The bottom portion of the screen also shows events and the user's account, allowing the user to have certain information in their account.

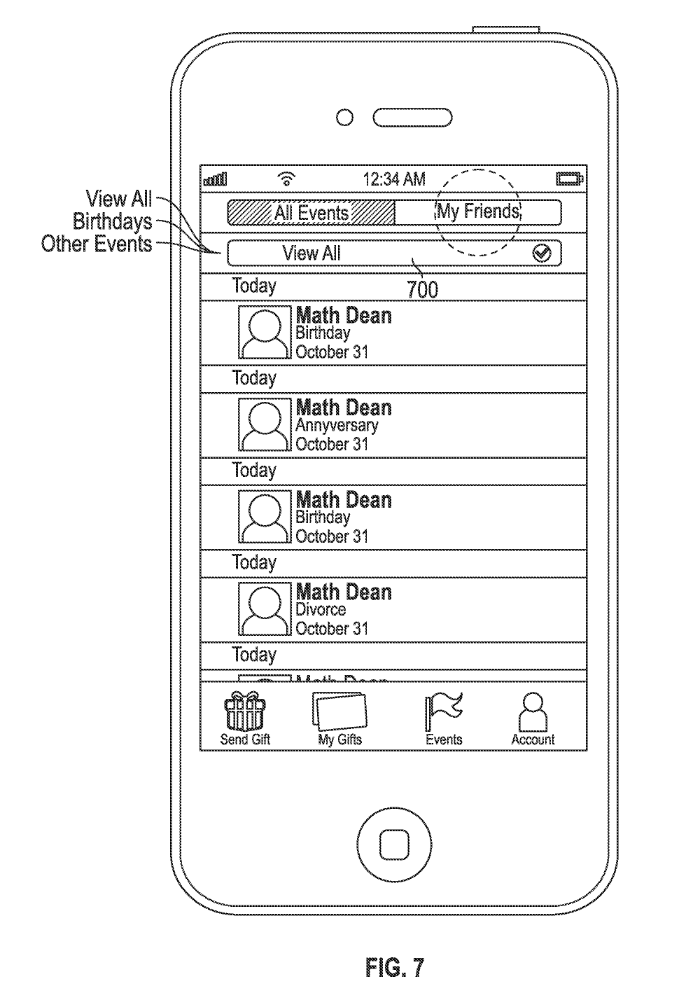

The events can include events and friends, where the friends are received from the social network. This also provides events about the user's friends, such as dates and anniversaries for the user's friends. FIG. 7 shows the user's friends and their different anniversaries such as birthdays, anniversary, and the like. Also, the view selector 700 allows selecting between viewing all different events, viewing the only birthdays, or viewing only other events.

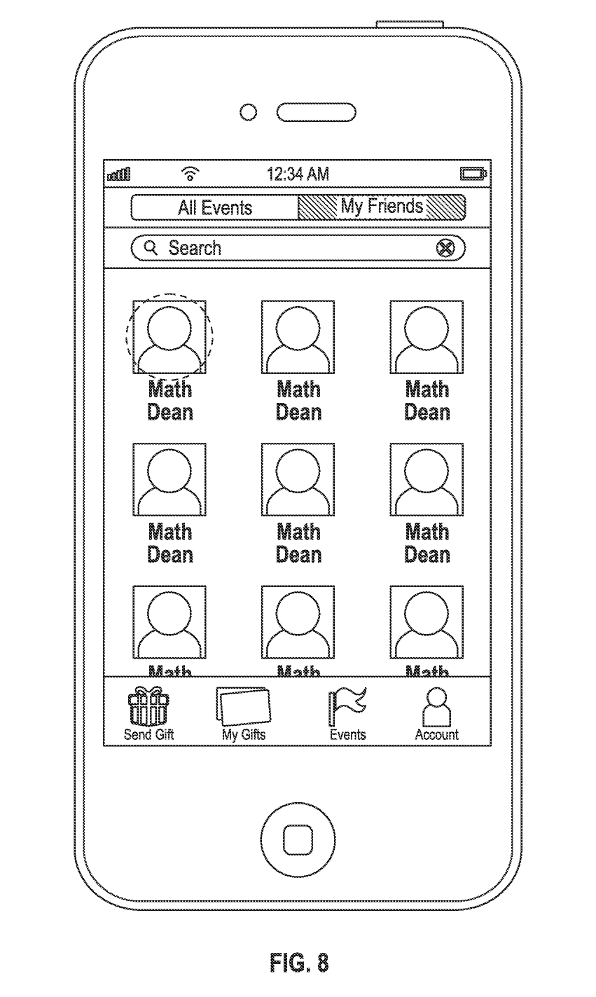

FIG. 8 shows the users different friends as obtained from the social network, including friend number 1; 800, friend number 2; 801, friend number 3; 802, and the like. Selections such as 805 can be made by choosing friend(s) directly from the social networking module, by direct contact information (email address, phone number), or by making a selection directly from an event/guest list.

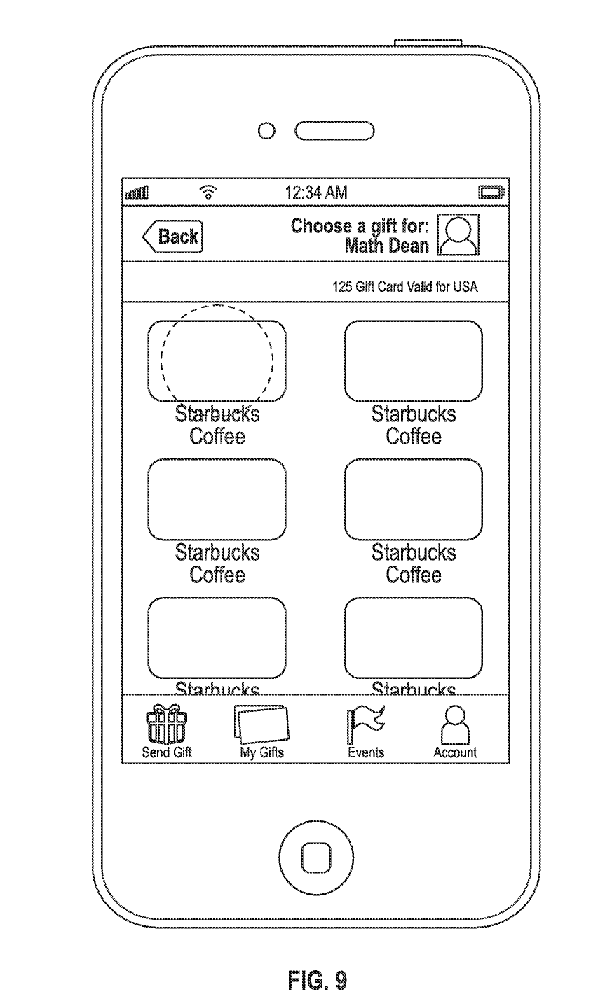

Once an individual is selected, shown as 805, this brings up the screen 900 of FIG. 9, showing a plurality of popular vendors are displayed for selection, the plurality of vendors including Starbucks 905, McDonalds 906, BestBuy 907, as well as any other possible vendors from which the gift card can be purchased, in an embodiment. The vendors may be ordered by popularity, location, or recommended based on prior purchase history. Additionally, vendors may be prioritized for a fee to have their establishment prioritized at the top of all lists.

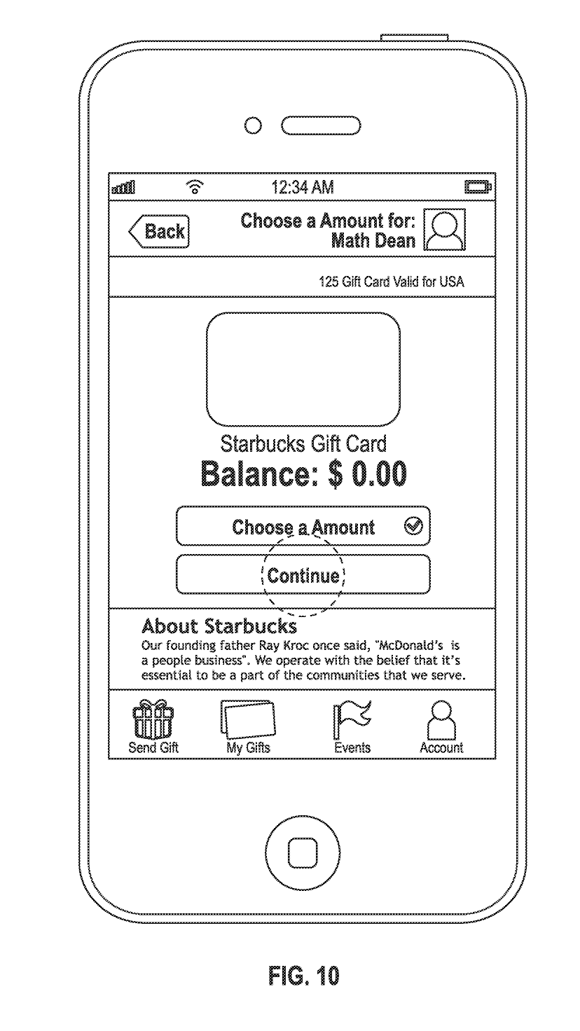

Once a vendor is selected shown as 915, more information is displayed relating to the vendor as shown in FIG. 10, as well as the option to select a gift card value from the pulldown menu 1000, which can allow either selecting a pre-set pulldown menu, or typing in the amount. There can also be a display screen 1005 which can show the vendor logo, or Vendors may provide additional multimedia content, such as audio, video, or photos, which can provide additional information about their establishment or otherwise encourage the user to select them as a gift card vendor.

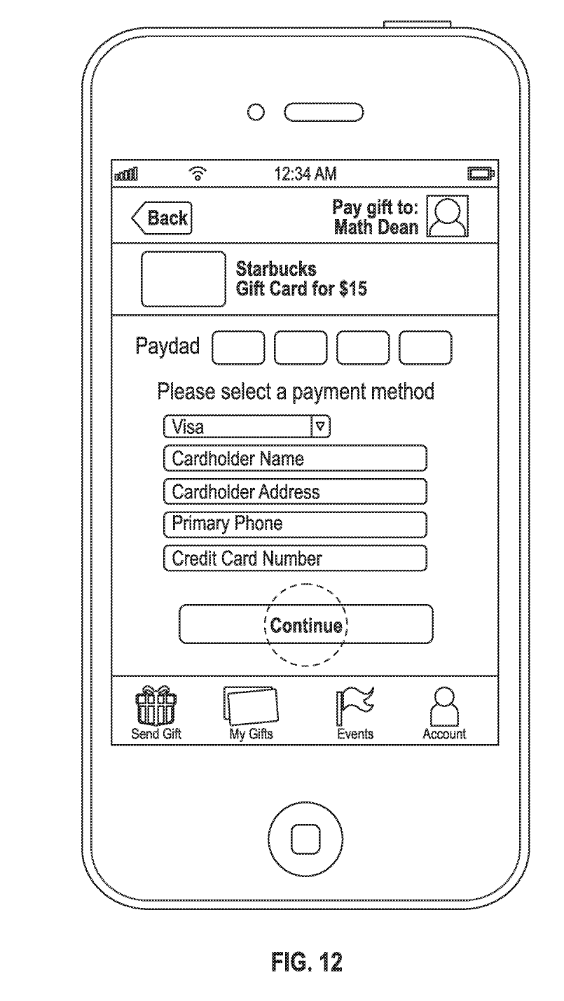

Once a value is selected, the system obtains payment for the amount e.g. by using a preset payment form such as a payment form which the user has previously entered into the application or by using the payment screen of FIG. 12. Again, FIG. 12 shows that a gift to Ralph Swank 1200 has been received, or selected, and this gift is a Starbucks gift card for $15. FIG. 12 shows the user can use a new or previously entered credit card at 1210, or can use another service such as PayPal.

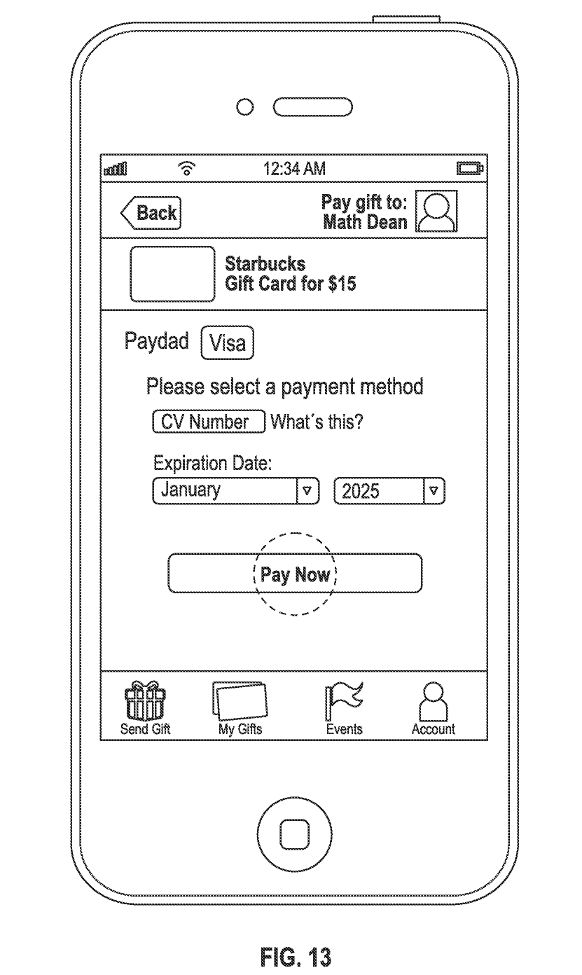

FIG. 13 shows entering the remaining information about the credit card such as CV number and expiration date, and finishing the payment. This obtains payment for the gift card, thus providing the card to the user.

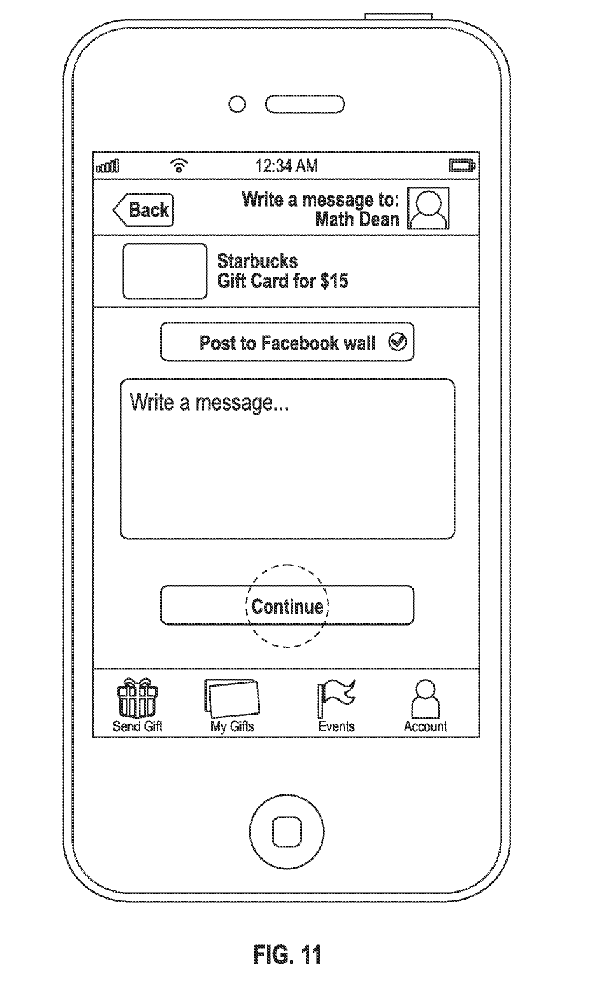

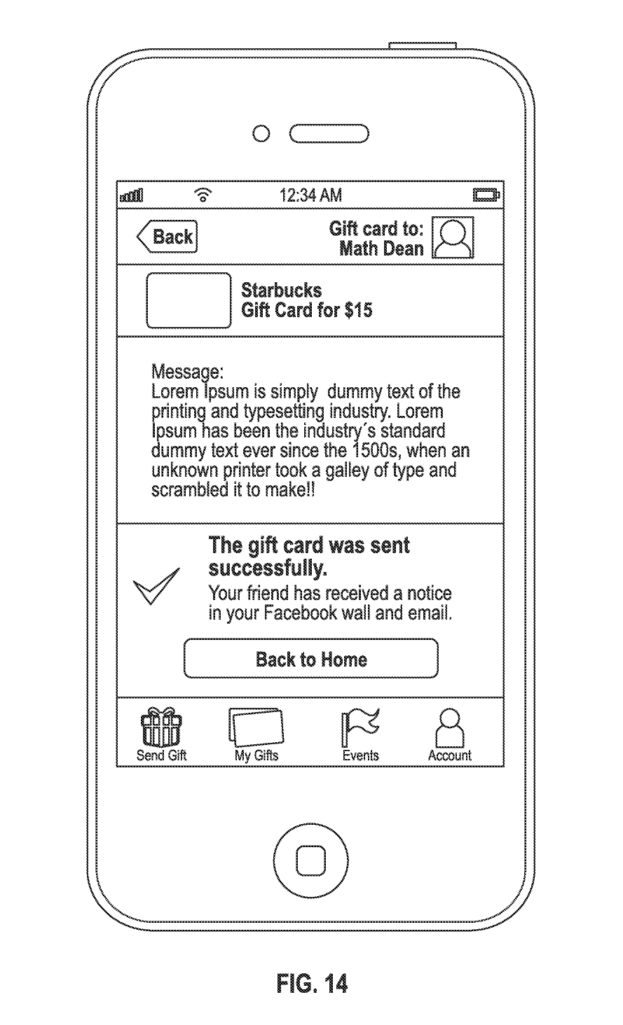

This brings up the screen of FIG. 11, which shows that a gift card has been purchased as 1100, here in the amount of $15. The user then gets the option to write a message at 1105, which can be a personalized message to the recipient 1106 of the gift card. Once the message has been written, the user gets the option to post this to one of the social networks shown as the button 1110. Here, the post is made to the user's Facebook wall, and in this embodiment Ralph Swank would receive the message indicating that they have received the card on their Facebook wall shown as FIG. 14.

If an external social network is selected and permission is granted, the gift card purchasing module instructs the external social network integration module to make a post comprising the recipient, vendor, and/or message within the external social network. For example, the user may post their message to the recipient's Facebook wall along with the value and vendor. This will encourage more digital gifts to be sent to the recipient, as well as introduce the subject matter of the embodiment to new users. After the transaction is complete, a confirmation is provided to the sender.

In an alternative embodiment, the user may elect to send vendor credit as opposed to selecting a vendor when purchasing a gift card. The vendor credit is equal to the value selected by the sender and can be applied to the vender(s) of the recipients choosing. This option provides greater flexibility to the sender, who may not know which vender the recipient prefers.

In a further alternative embodiment, upon receiving a digital gift having a value and pre-selected vendor, the recipient may elect to convert the value to vendor credit and reselect their vendor(s). This vendor conversion may be limited by a time period after receipt of the gift card.

In a further alternative embodiment, the sender may elect to send brand credit as opposed to selecting a vendor or vendor credit. Here, the digital gift is credit for a particular brand from multiple different retailers. the sender selects a brand (ex. Ralph Lauren, Gucci, etc.) and selects a desired value. The sender of the brand credit can also be a brand or vendor for the purpose of rewarding customers. This brand credit can then be applied by participating merchants (ex. Nordstrom, Macy's, etc.) for purchases made through them.

The recipient's location is verified through geo-positioning built into the mobile device, and when a participating merchant and corresponding geopositioning is confirmed, the brand gift is converted to vendor credit for the vendor selected. Brand credit can only be applied through participating merchants and are restricted to all other nonparticipating merchants.

Additionally, a merchant will further restrict brand credit to purchases of the specific brand selected by the sender. Alternatively, the recipient may purchase the full amount and the merchant will “gift” the amount equal to the brand credit as a vendor credit to be used for future purchases with them.

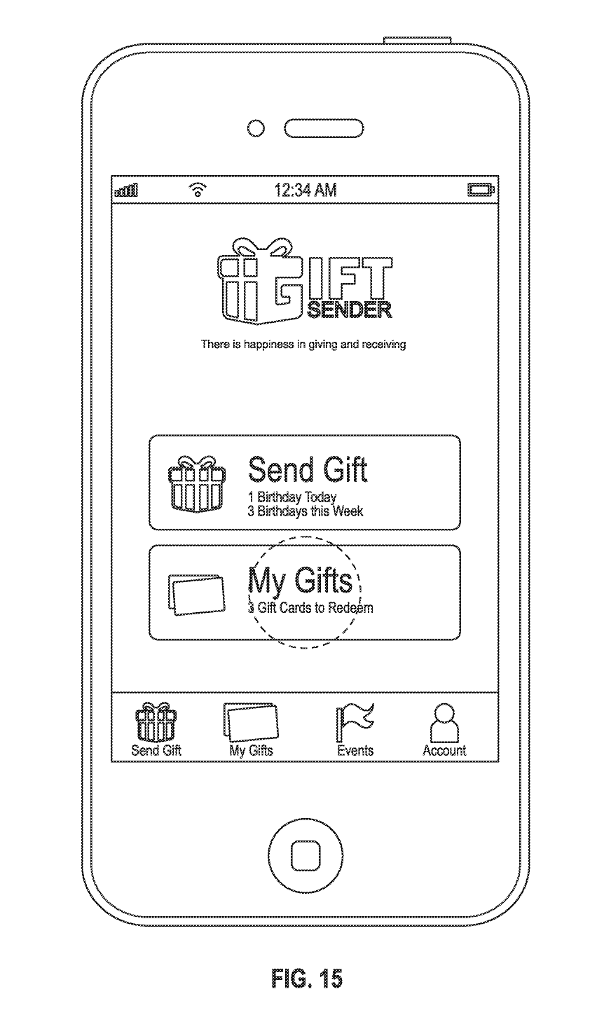

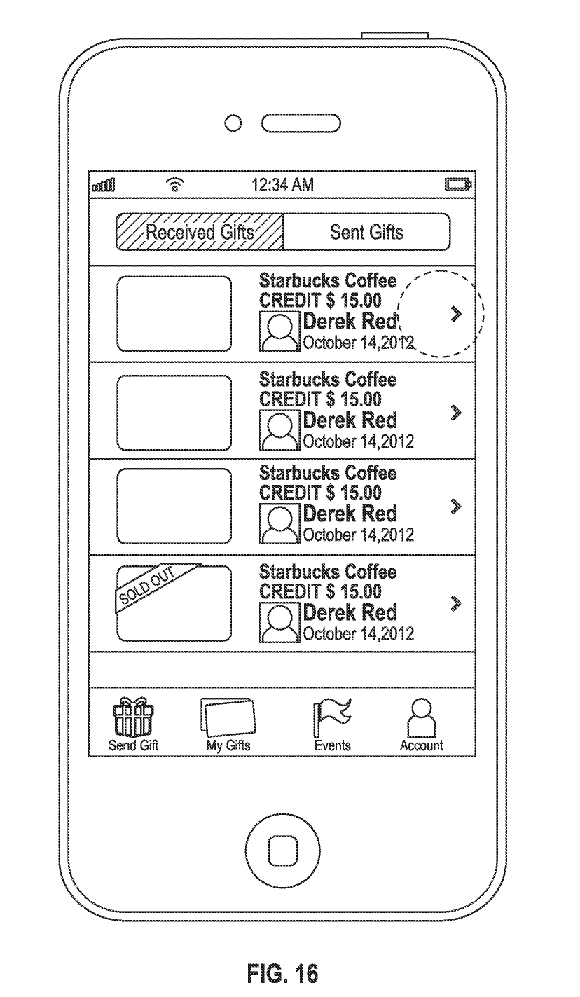

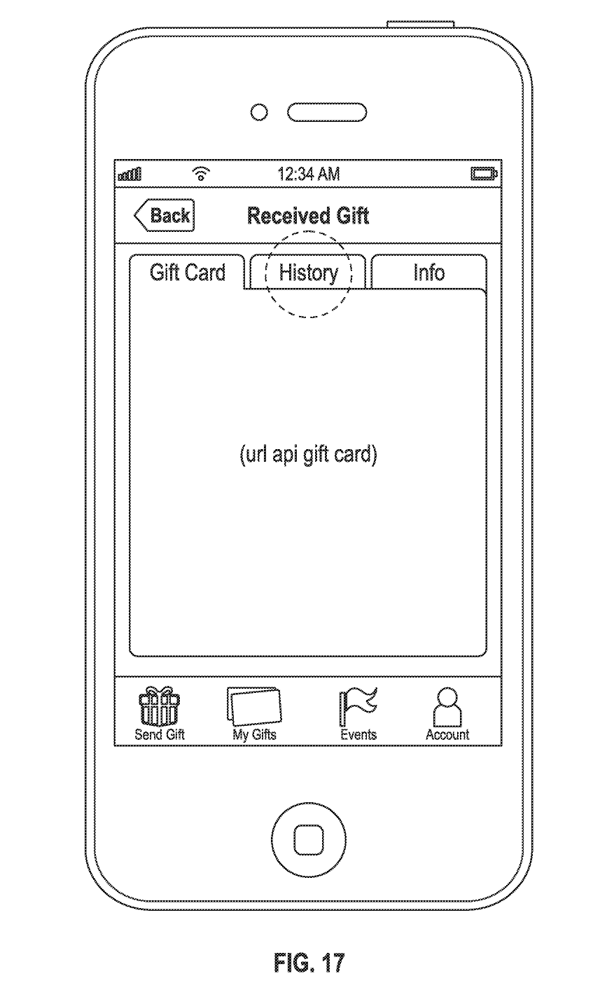

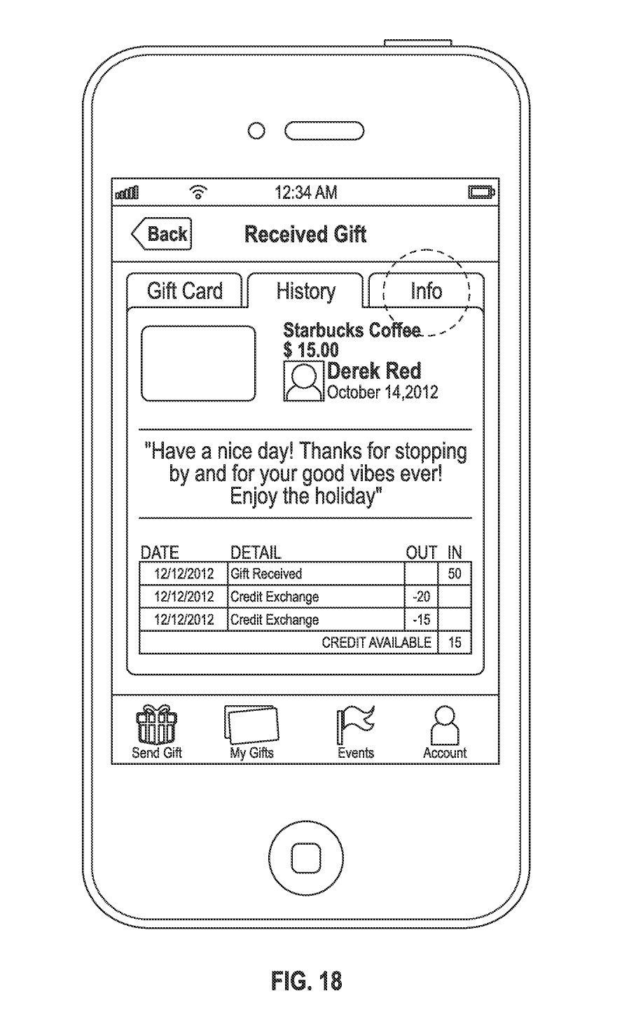

The gift card transaction module can also be selected in FIG. 15, by selecting the My gifts icon 1500. This provides a screen shown as 1600 in FIG. 16 where the user has the choice to view received gifts 1605 and sent gifts 1610. When the user choose received gifts, the user can see all the gifts they have received from others such as gift 1611 1612 and the like. This also shows the status of the gift, for example gift 1614 is shown is sold out, indicating that the gift has already been used. The user can select a gift for example selecting gift 1611 at 1620, to bring up the screen of FIG. 17 which has tabs showing information about the gift card, including the gift card tab 1702 showing the gift card itself. The gift card can be a digital facsimile of the gift card, and can include for example a scannable code 1700 which can be scanned at the vendor to provide the information of the gift card. The user can also select the history tab 1704 to bring up the screens of FIG. 18 showing the history of use of the gift card, which shows that this was a Starbucks coffee gift card for $15 at 1800, shows the message received from the sender and 1805, and shows the different uses of the gift card at 1810.

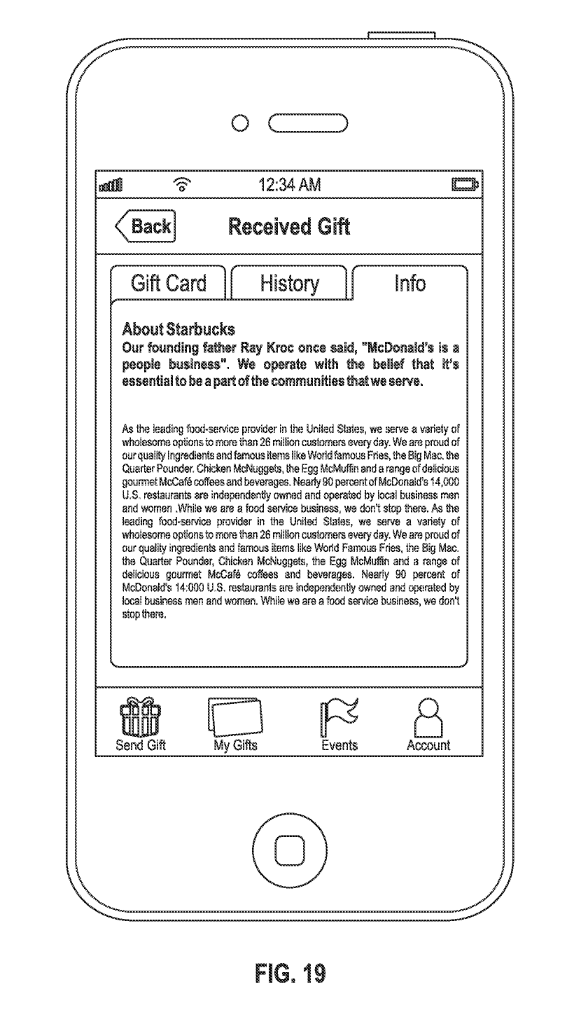

The user can also select the information tab 1820 which brings up the screen of FIG. 19 which provides information screen 1900 about Starbucks.

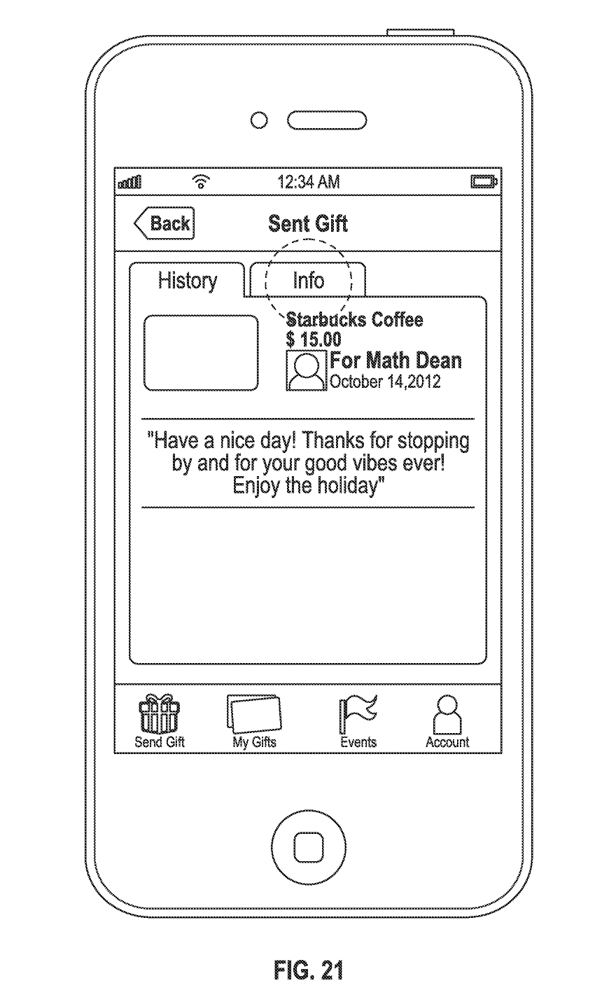

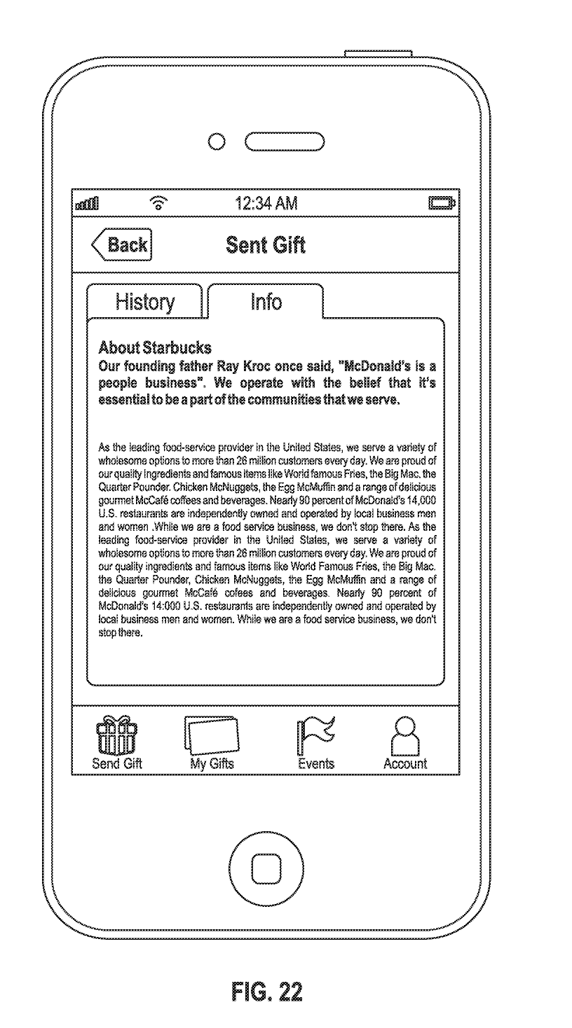

If the user selects the sent gifts tab 1610 in FIG. 16, the user gets a list of all the cards that they have sent to others. Each center gift can be selected as shown as 2000, to bring up the screen shown as FIG. 21 which has a history tab 2100 and information tab 2110. The history tab shows the user sending the Starbucks coffee gift, the date, and the message 2120 that was sent with the gift. The user can also select the info tab 2121, to bring up the tab of FIG. 22 which provides information about the vendor that will redeem the digital gift.

Additionally, the sender may be provided special offers from selected vendors as a token of appreciation e.g. this may be provided as part of the information page as a coupon code or other kind of special offer.

For received gifts, the user is provided with a list of gifts received, with each list item comprising the sender's name, the date sent, the selected vendor, and the remaining balance. Here, the user may elect to convert a selected vendor to one of their choosing. Each list item can also be selected to provide a full transaction history. Additionally, when viewing list items, special offers and other advertisements may be provided by the selected vendor (or preferred vendors if no vendor has been selected). These special offers may be directly purchased through the advertisement, using the balance of the gift card for payment and the personal information of the user for shipping. In a preferred embodiment, this process will comprise as few steps as necessary, as all processing information has been provided to the system. If the card balance is not large enough to satisfy the offer amount, the remaining balance can be paid using vendor credit or traditional forms of payment.

The gift card transaction module will also provide a way to pay at specific vendors.

Here, the gift card transaction module provides a scannable code, e.g, a barcode or other individualized code. When selected, and this code will be either scanned or entered by the vendor. The gift cards can be used at a physical location or through online systems. In an alternative embodiment, wireless technology, such as NFC technology, may be incorporated to transfer payment. Additionally, location-based services, such as GPS, may be used to record the location of the purchase. If a remaining balance is left on the digital gift card, this amount, and the details of the transaction, will all be listed within the gift card transaction module.

Additionally, the gift card transaction module tracks one or all purchases made by the user. The gift card transaction module then calculates a percentage of the total (unredeemed) purchases and provides this value to the user as vendor credit, which can then be applied to a vendor or given as a gift.

For example, the gift card transaction module may return 1% of all purchases made as vendor credit to the user. A preset threshold (ex. $25) may be used to encourage additional purchases up to the threshold. This threshold may be tiered to further encourage future purchases by the users ($25, $50, $100, etc).

In an alternative embodiment, the gift card transaction module is capable of calling the gift card purchasing module for adding value to an existing digital gift card.

In a further alternative embodiment, physical cards are sent in addition to their digital counterparts.

In yet a further alternative embodiment, existing physical gift cards may be entered into the present invention, permitting their transaction history to be seen easily.

In still a further alternative embodiment, a gift card exchange module may be implemented, where users may trade gift cards between one another and then gift them to others. In one embodiment, this exchange is carried out over the social network site but automatically excludes the sender of the gift from the exchange process, so that the gift sender cannot see that their recipient is “regifting” their card.

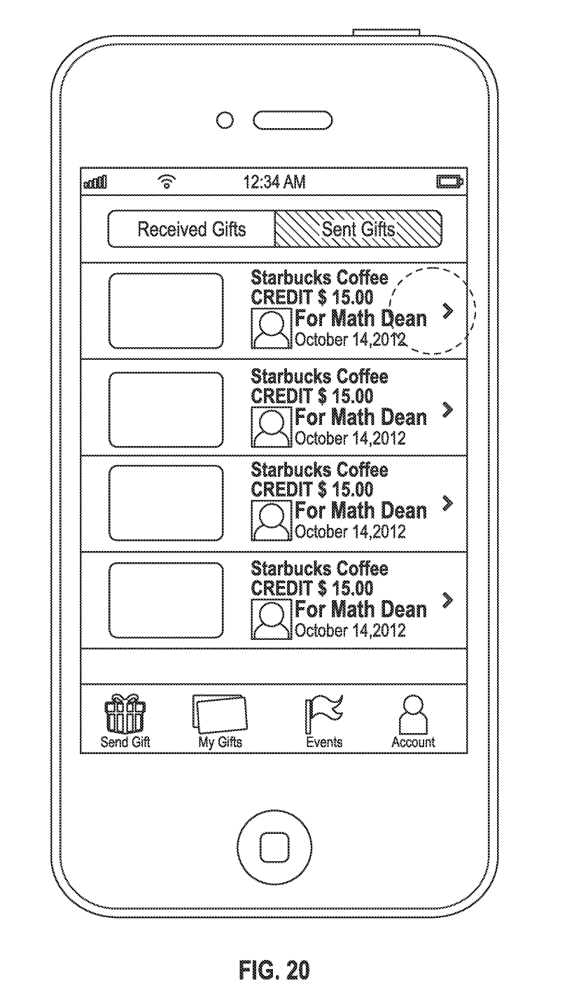

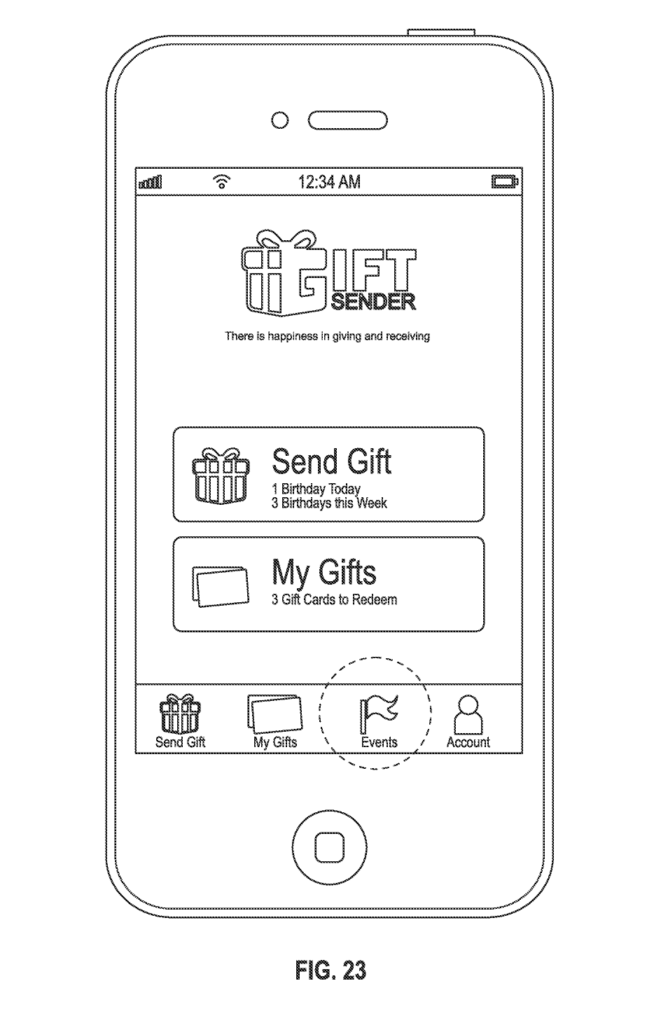

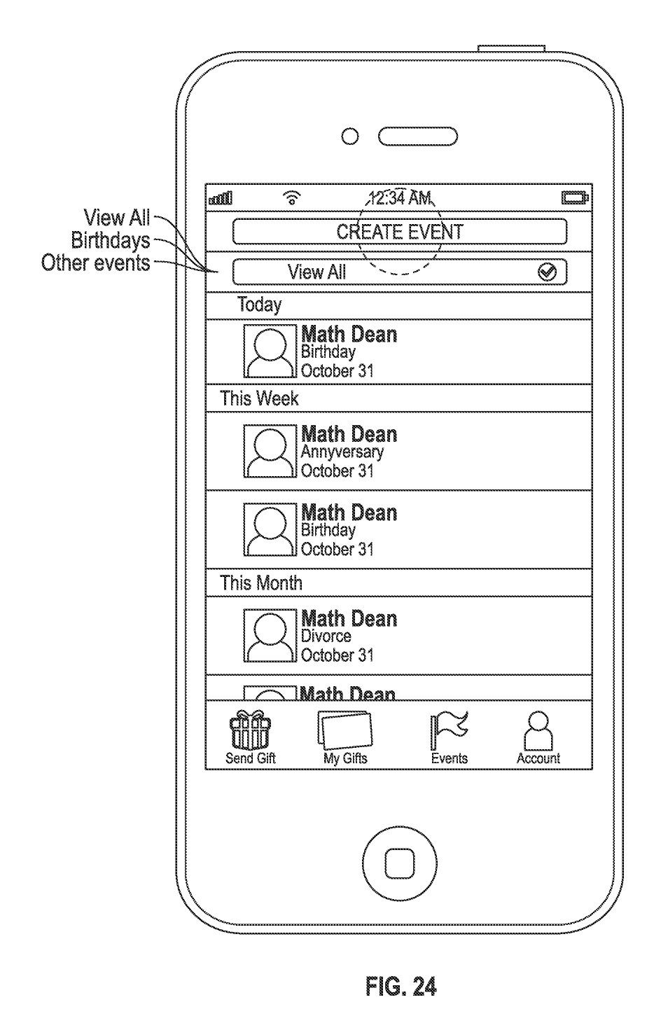

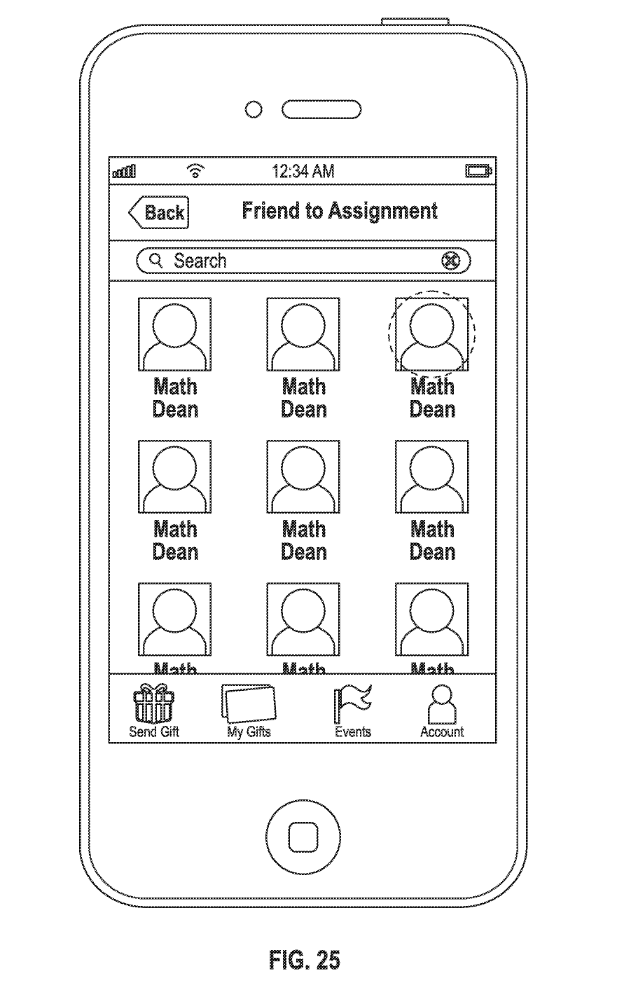

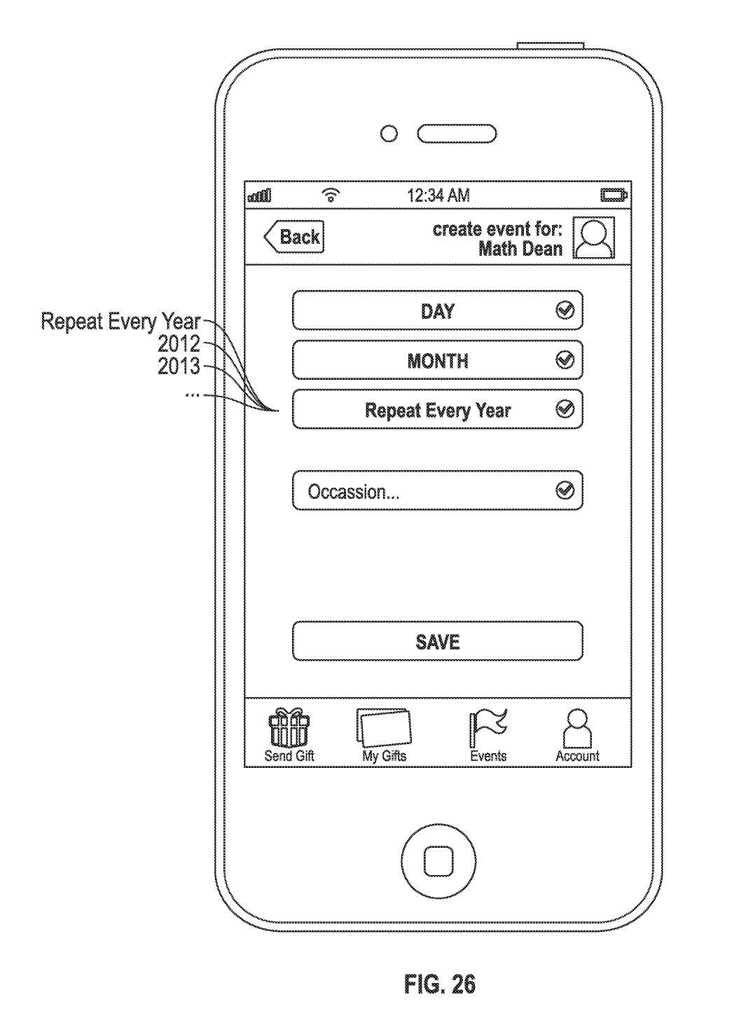

The events are shown in FIG. 23, by selecting the event tab on the main screen. This brings up the event screen 2400 of FIG. 24, which allows the user to create an event shown as 2410, or to view the different events shown us 2420. FIG. 24 is showing viewing the different events, which can be the same event shown in FIG. 7. However in FIG. 20 for the user has the option to select the creative event tab 2410 shown as selection 2411. This bring up the screen of FIG. 25 where the user is shown a list of all their friends, and allowed to select one of them here, the user is shown selecting the friend 2500 in order to create an event for that friend shown as FIG. 26. FIG. 26 shows that the user is creating an event for the friend Ralph Swank and 2600, which shows selecting the day for the event 2610, the month for the event at 2620, and the repetition for the event at 2630, which can be repeated every year, or just one time. 2640 indicates the occasion for the event, which can be birthday, anniversary, and the like. Once properly set, this can be saved at 2650. This can create a new event that can be stored either in the local database or both in the local database stand and a remote database.

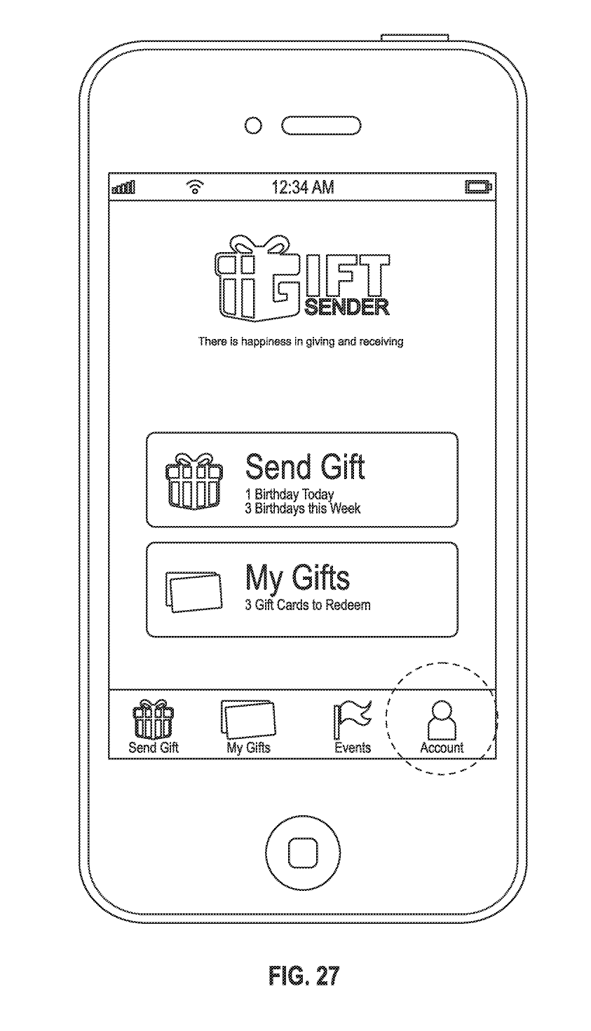

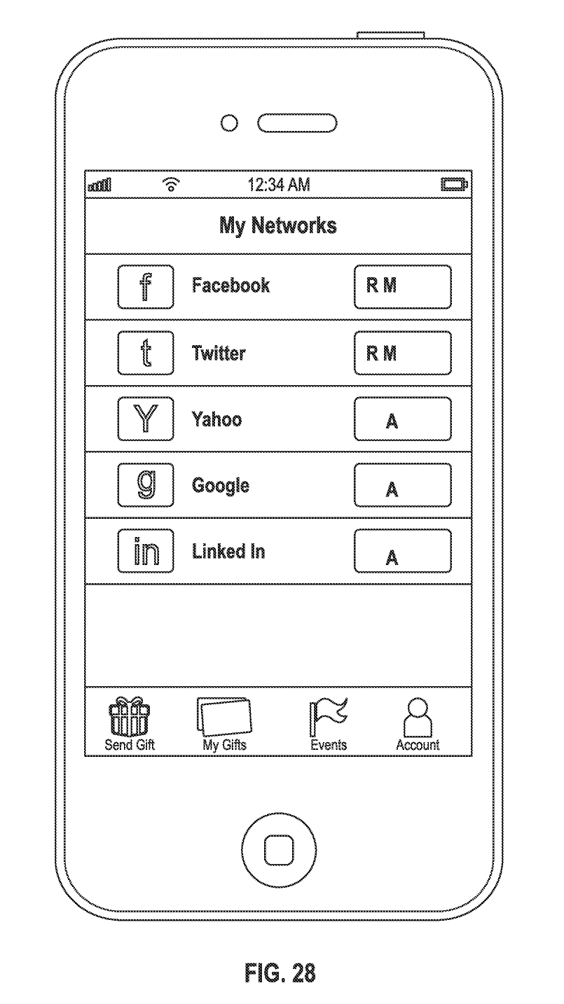

FIG. 27 shows selecting the account tab 2700 in the main screen, bringing up the list of network connection shown as 2800 in FIG. 28. This shows the different social networks, such as Facebook 2800, and the login information 2802 for each of those social networks.

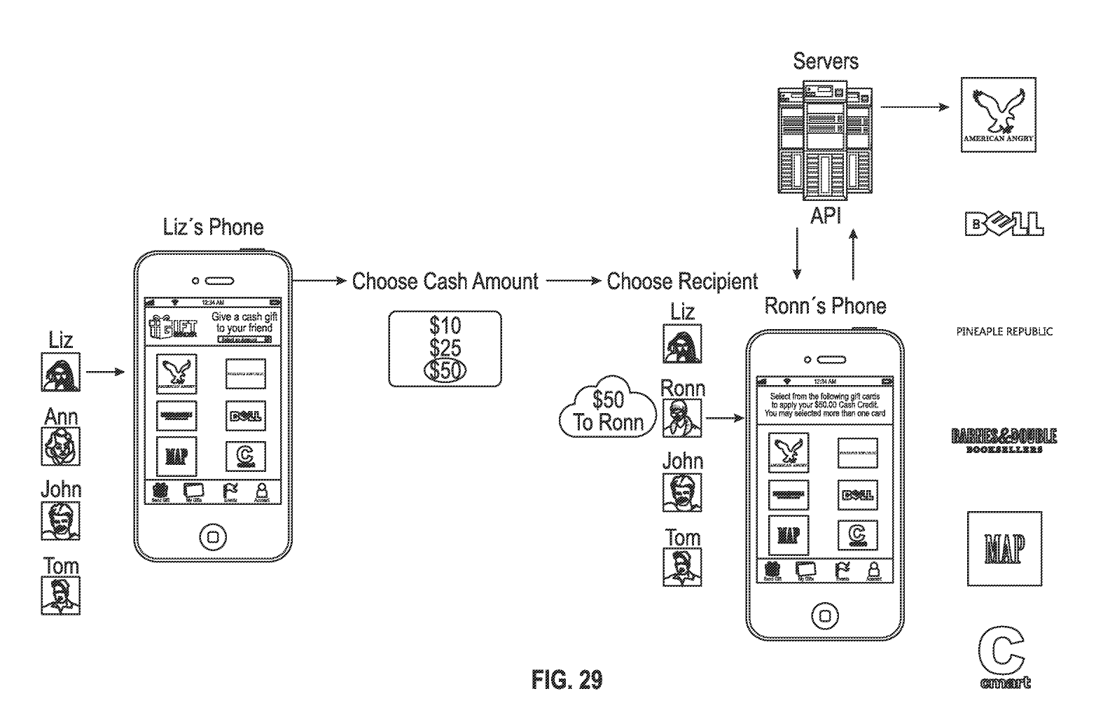

The overall flow of the process is shown in FIG. 29, which shows the different users 2900 associated with the phone. The user such as 2902 brings up the gift card app on their 2904 on their phone 2910. The user selects a gift amount 2912, ends chooses a recipient 2914. This is then sent to the recipient's phone 2920 and stored in the servers at 2925. This gift card can then be used at any of the different gift card possibilities 2930.

While the above description contains specific details regarding certain elements, devices, and other teachings, it is understood that embodiments of the invention or any combination of them may be practiced without these specific details. These details should not be construed as limitations on the scope of any embodiment, but merely as exemplifications of the presently preferred embodiments. In other instances, well known structures, elements, and techniques have not been shown to clearly explain the details of the invention.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example while the above describes only certain kinds of users networks and gifts, or any other kind of user, network for gift can be similarly accommodated using this system. Detections using this tec will hnique, it should be understood that there are many more kinds of applications. This can be used to find, for example, logos and advertisements or in videos of various sorts. In sports, this can be used to find logos on team jerseys or numbers on the team jerseys. This can be used for other applications other than sports games, to follow individual items or people in a crowd.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A Computing system comprising:
a processor;
a display, displaying information based on operations by said processor; and
a memory, storing information,
wherein said processor operates to communicate with a social networking website that stores connections between people, and uses the users login credentials to communicate with said social networking website, wherein said processor automatically obtains event information about friends of the user from said social networking website, and displays said event information on said display,
wherein said processor controls forming a user interface that controls the user purchasing at least one digital gift for a recipient who is one of said friends having an amount and being redeemable for goods and/or services, communicates information indicative of the digital gift to said at least one of said friends, and automatically posting information about the digital gift having been purchased on said social networking website in a way that is shown to users of the social networking website other than said user and said recipient.

2. The system as in claim 1, further comprising a housing holding said processor display and memory, also holding a battery, forming a portable computing system.

3. The system as in claim 2, wherein said computing system is within a cellular phone.

4. The system as in claim 1, wherein said processor shows a list of friends, along with a list of said events, wherein said events include at least anniversaries and birthdays.

5. The system as in claim 1, wherein said digital gift is for an amount and does not specify a vendor.

6. The system as in claim 1, wherein said digital gift is credit for a particular brand from multiple different retailers.

7. The system of claim 1, further comprising an additional memory storing a history of using the digital gift.
